(19) United States
(12) Patent Application Publication
(10) Pub. No.: US 2025/0031636 A1
(43) Pub. Date: Jan. 30, 2025

(54) IRRIGATION DEVICE AND METHODS OF USE

(71) Applicant: DripScrew, Inc., Lindsay, CA (US)

(72) Inventor: David Ross, Lindsay, CA (US)

(21) Appl. No.: 18/490,770

(22) Filed: Oct. 20, 2023

Related U.S. Application Data
(63) Continuation-in-part of application No. 29/855,563, filed on Oct. 4, 2022.

(51) Int. Cl. A01G 25/06

(52) U.S. Cl. CPC A01G 25/06

(57) ABSTRACT

The present invention relates to plant irrigation devices and systems. The presently disclosed plant watering devices are operable and can be arranged to deliver water directly to the root system of a plant. Also, the present disclosure relates to plant watering systems using the presently disclosed devices. Also, the present invention relates to plant watering devices that have an exterior threading that can be easily inserted into the ground by rotation like a screw.

This application is a continuation-in-part of and claims priority to application of U.S. Design patent application Ser. No. 29/855,563, filed Oct. 4, 2022, pending, which is incorporated herein by this reference in its entirety.

### FIELD OF THE INVENTION

The present invention relates to plant irrigation devices and systems. The presently disclosed irrigation devices are operable and can be arranged to deliver water directly to the root system of a plant.

### DISCUSSION OF THE BACKGROUND

Conventional drip irrigation systems have limitations and problems, particularly with respect to irrigating plants. Plants have extensive root systems that spread out far from the trunk or stem. Traditional drip irrigation systems, which often employ a limited number of emitters placed near the trunk or stem, may not effectively water the entire root system. This can lead to uneven water distribution, causing some roots to be overwatered while others remain dry. Drip irrigation also primarily delivers water to the surface of the soil. For mature plants with deep root systems, this surface watering may not adequately reach the deeper roots, potentially stressing the plant. Also, drip systems are usually not buried or covered (e.g., with mulch) because it is impractical in the agricultural setting. Thus, water can evaporate before it penetrates the soil, leading to inefficient water use.

Above-ground drip lines are susceptible to damage from gardening activities, animals, or environmental factors. Damaged lines can result in water wastage and uneven distribution. The emitters in drip systems can become clogged with sediment, minerals, or organic matter. This can lead to uneven water distribution or complete blockage, requiring regular maintenance and monitoring.

Drip irrigation has its challenges, especially for plant watering. Therefore, improved, efficient, and reliable water delivery systems for plants are needed.

### SUMMARY OF THE INVENTION

The present invention relates to plant irrigation devices and systems. The presently disclosed irrigation devices are operable and can be arranged to deliver water directly to the root system of a plant. Also, the present invention relates to plant watering devices that have an exterior threading that can be easily inserted into the ground by rotation like a screw. Further, the present disclosure relates to plant watering systems using the presently disclosed devices.

The present invention provides a specialized irrigation device that is solution tailored to provide targeted irrigation to the root system of one or more plants, ensuring that water reaches beneath the soil surface. Central to this system is a perforated hollow cylindrical tube designed to facilitate the even distribution of water. The present invention relates to an irrigation tube design that includes at least a portion that can be placed in a subterranean position in the root system of a plant in order to facilitate direct application of water to the root system. The tube design may be rigid and able to maintain its shape when placed in the soil and may include a tapered tip that facilitates placement in the soil.

The tapered end and the threading on the exterior of the tube allow the device to be easily driven into the ground to place the tube in the root system of a plant. By positioning the tube in this manner, the device can bypass the upper soil layers and deliver water directly to the roots. This design not only ensures that plants receive an optimal amount of water to plant roots and promotes water conservation by minimizing surface runoff and evaporation. The device of the present disclosure offers an efficient and effective method to water plants where water supply might be limited.

The device of the present disclosure includes at least one cylindrical tube that is structured and arranged to receive water from an irrigation delivery tube (e.g., drip irrigation tubing). The irrigation delivery tube may connect to and be in fluid communication with an upper end of the tube. The tube may include an upper end that has a polygonal shape that allows the upper end to be grasped by a tool, such as a hex wrench, a pipe wrench, a crescent wrench, or other tool that allows a user to rotate the tube to drive it into the ground. The upper end may include a receiver from the irrigation delivery tube, such as a port for inserting or a barb for pressure fitting the irrigation delivery tube.

The tube may include a plurality of perforations for allowing the flow of water or other fluid from the interior of the tube into the surrounding soil. The perforations may be distributed around the external threading, e.g., in columns along the length of the tube. In other examples, the perforations may be arranged in a spiral pattern in parallel with the external threading or other patterns.

In some embodiments, the tube may include a filtering structure to prevent the incursion of soil and debris through the perforations into the interior of the tube. The filtering structure may be adjacent to an internal wall of the tube.

### BRIEF DESCRIPTION OF THE DRAWING

FIG. 1 shows a perspective view of an irrigation device according to an embodiment of the present invention.

FIG. 2 shows a perspective view of an irrigation device according to an embodiment of the present invention.

FIG. 3 shows a first side view of an irrigation device according to an embodiment of the present invention.

FIG. 4 shows a second side view of an irrigation device according to an embodiment of the present invention.

FIG. 5 shows a third side view of an irrigation device according to an embodiment of the present invention.

FIG. 6 shows a fourth side view of an irrigation device according to an embodiment of the present invention.

FIG. 7 shows a top view of an irrigation device according to an embodiment of the present invention.

FIG. 8 shows a bottom view of an irrigation device according to an embodiment of the present invention.

FIG. 9 shows an environmental view of an irrigation system according to an embodiment of the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

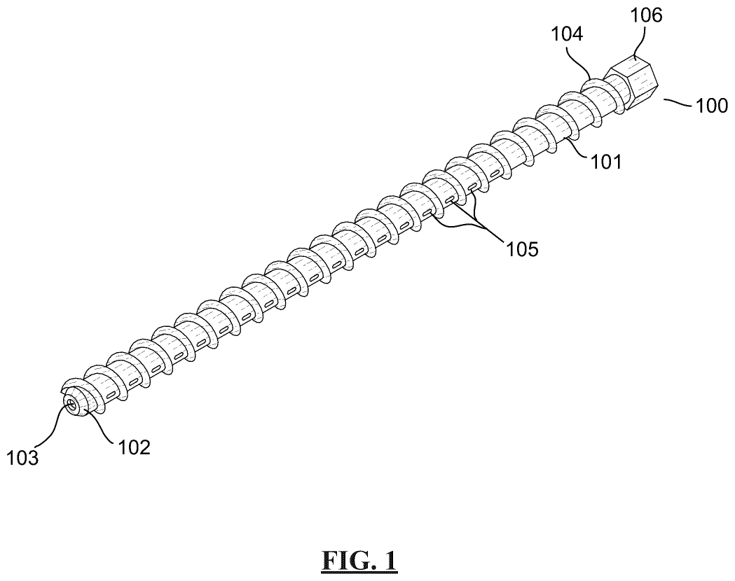

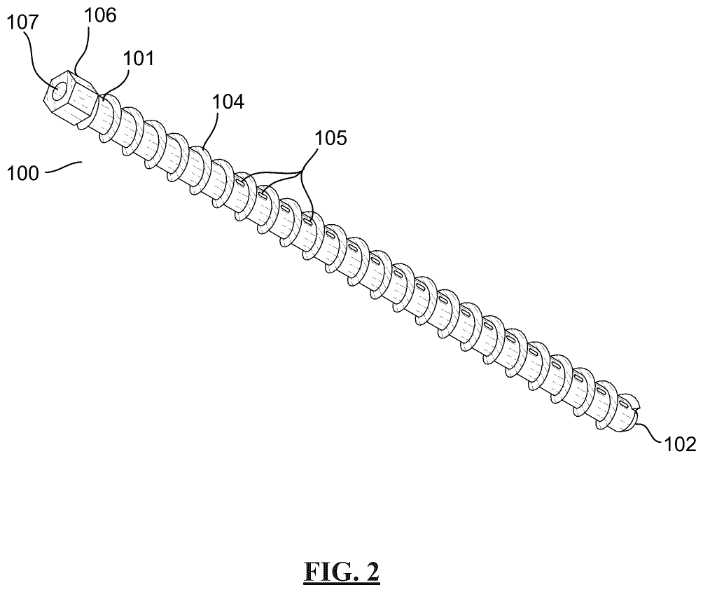

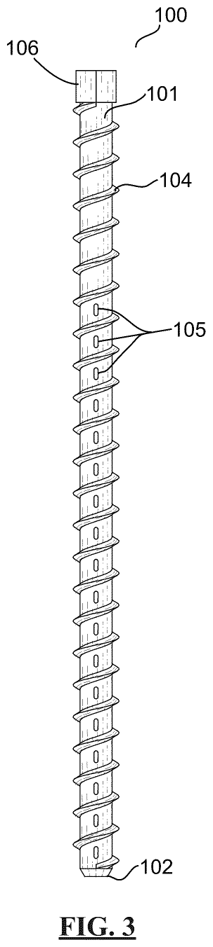

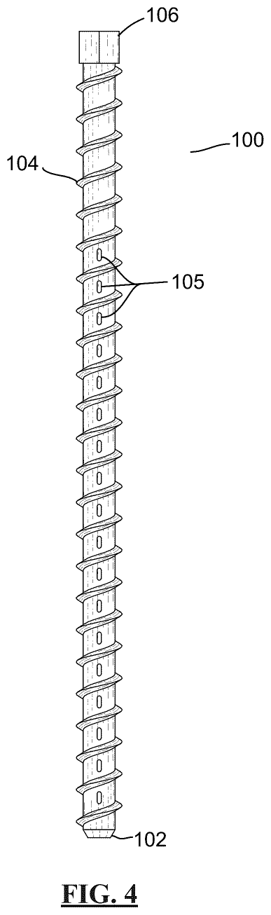

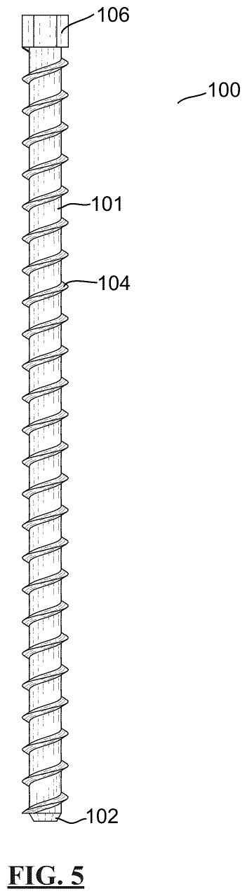

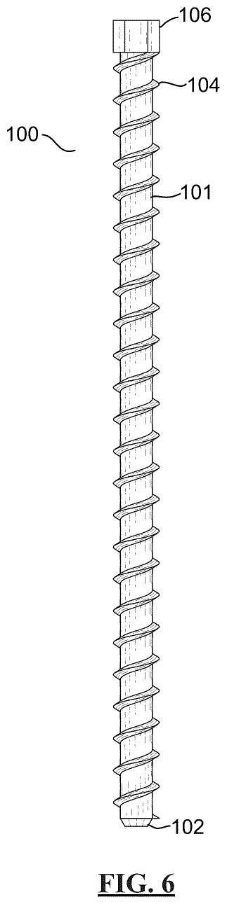

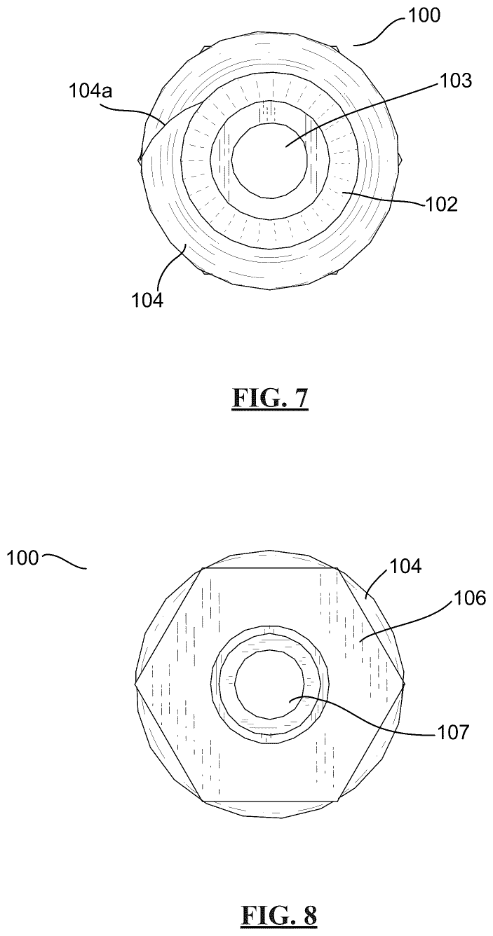

FIGS. 1-8 show an exemplary irrigation device (an irrigation spike) 100 for insertion into the soil to deliver water in the proximity of a root system of a tree or other plant with substantial root system. The irrigation device 100 may include a cylindrical tube body 101, a distal tapered tip 102, a distal water emitter hole 103, a spiral threading 104, peripheral emitter holes 105, a polygonal head 106, and an irrigation line receiver 107 at the proximal end of the irrigation device. The irrigation device 100 has a screw-like construction with a tapered end 102 and a threading 104 that allow the irrigation device 100 to be driven into the soil near a tree or other plant by rotating the device 100. The polygonal head 106 allows for a wrench, hexagonal driver, or other tool may be used to grasp and rotate the irrigation device 100 into the ground. The irrigation device 100 may then be used to deliver water, or a water/nutrient mix, to the subterranean root system of the tree or plant.

The tube body 101 comprises a hollow cylinder with an upper end and a lower end and is configured to permit the flow of fluid to the root system of a tree or plant. The tube 101 may have a length of about 6 inches to about three feet, which may be varied in order to accommodate the anatomy of the tree or plant. Different plant species and varieties have different root systems of differing depths. The irrigation devices 100 of different lengths may be applied to different kinds of plants. The irrigation device 100 may be inserted into the soil such that the polygonal head 106 is at a position that is about 1 inch above the ground. However, it is to be understood that irrigation device 100 may be partially inserted into the soil in appropriate circumstances, such as smaller trees or plants with shallow root systems. The tube structure 101 and external threading 104 of the irrigation device 100 may be made from a durable, rigid polymeric material, such as polyvinyl chloride (PVC, e.g., Schedule 80 PVC), chlorinated polyvinyl chloride (CPVC), acrylonitrile butadiene styrene (ABS), high-density polyethylene (HDPE), polycarbonate (PC), or other appropriate materials that can withstand the stress of insertion of the irrigation device 100 into the soil, which may be of varying densities and hardness. In some embodiments, the tube material may be tinted with pigments and/or coated with a UV reflective material (e.g., titanium dioxide (TiO2) coating, acrylic-based coating, zinc oxide (ZnO) coating, polyurethane coating with UV inhibitors, clear UV-resistant varnish, or other appropriate materials) to resist damage from ultraviolet light. In other embodiments, the tube structure 101 and external threading 104 of the irrigation device 100 may be made from a durable, rigid metal material, such as aluminum, galvanized steel, stainless steel, brass, or other appropriate materials that can withstand the stress of insertion of the irrigation device 100 into the soil.

The cylindrical tube 101 permits water to flow out of tube 101 at a selected depth and into the surrounding soil. The tube 101 may include a plurality of perforations 105 through the sidewall of the tube 101. Perforations 105 are between about 1 mm to about 10 mm in diameter. The perforations 105 may be formed on the surface of tube 101 in a pattern to (1) accommodate the external threading 104, (2) evenly distribute water around the circumference of the tube 101, and (3) maintain the physical strength and integrity of the cylindrical tube 101 to allow the tube 101 to physically withstand being driven into the soil. The perforations 105 may be arranged in parallel lines along the length of tube 101 with the perforations 105 being spaced apart along the length of the tube 101 at a distance in a range of about 0.5 cm to about 2 cm. There may be about 10 to about 40 perforations 105 in the tube 101. The tube 101 may include two columns of perforations 105 on opposite sides of the tube 101. In other embodiments, the tube 101 may include three columns of perforations 105 separated 120° along the circumference of the tube, four columns of perforations 105 separated 90° along the circumference of the tube, or other arrangements. Other perforation patterns are contemplated in the scope of the present invention.

The tube 101 may include a filtering structure on the interior of the tube 101. The filtering structure may prevent the incursion of soil and debris through the perforations 105 into the interior of the tube 101. The filtering structure may be adjacent to an internal wall of the tube and may be a fine mess having a pore size in a range of about 0.1 mm to about 1 mm.

The tube 101 may have a tapering end 102 that extends from the bottom end of the tube 101. The tapered end 102 may assist in pushing ground, or soil, aside as irrigation device 100 is driven into the soil. The tapered end may have a tapering angle in a range of about 10° to about 45° relative to the outer side wall of the tube 101. The tapering end 102 may end at an orifice 103 at the distal end of the tube 101 that allows the passage of fluid into the soil. In some embodiments, the tapered end may be closed in a conical point or other tapered shape (e.g., a wedge, a pyramid, or other shape) that further aids in the insertion of the irrigation device into the soil. In such embodiments, the conical point or related shape may be integral to the tube 101. In other embodiments, the orifice 103 may have internal threading that allows a conical point or other tapered point component to be optionally threaded into the orifice 103. The conical point or other tapered point component may be made from a durable, rigid polymeric material, such as polyvinyl chloride (PVC, e.g., Schedule 80 PVC), chlorinated polyvinyl chloride (CPVC), acrylonitrile butadiene styrene (ABS), high-density polyethylene (HDPE), polycarbonate (PC), or other appropriate materials that can withstand the stress of insertion of the irrigation device 100 into the soil. In other embodiments, the conical point or other tapered point component may be made from a durable, rigid metal material, such as aluminum, galvanized steel, stainless steel, brass, or other appropriate materials that can withstand the stress of insertion of the irrigation device 100 into the soil.

The polygonal head 106 may be positioned at the upper end of the tube body 101 and may have a polygonal cross-sectional shape, such as a hexagon, square, or other polygonal shape that is operable to be gripped by a pipe wrench, hex wrench, polygonal drill bit, or other tool, allowing the polygonal head 106 can be engaged by the tool and the irrigation device 100 may be spun by the tool to engage the external threading 104 with the soil and drive the irrigation device 100 into the soil to place the irrigation device 100 in proximity to the root system of a tree or other plant. In some embodiments, the polygonal head 106 may be integrally formed with the tube 101 and be made of the same material. In other embodiments, the polygonal head 106 may be a separate structure that is attached to the tube 101 by a threaded connection (e.g., a locking pin or locking nut may be used such that the polygonal head 106 is not disconnected from the tube 101 when the irrigation device 100 is spun to drive it into the soil), push fit joint, pinned lap joint, grooved joint, or other appropriate connections. In some embodiments, the polygonal head 106 of the irrigation device 100 may be made from a durable, rigid polymeric material, such as polyvinyl chloride (PVC, e.g., Schedule 80 PVC), chlorinated polyvinyl chloride (CPVC), acrylonitrile butadiene styrene (ABS), high-density polyethylene (HDPE), polycarbonate (PC), or other appropriate materials that can withstand the stress of insertion of the irrigation device 100 into the soil. In some embodiments, the polygonal head 106 may be tinted with pigments and/or coated with a UV reflective material (e.g., titanium dioxide (TiO2) coating, acrylic-based coating, zinc oxide (ZnO) coating, polyurethane coating with UV inhibitors, clear UV-resistant varnish, or other appropriate materials) to resist damage from ultraviolet light. In other embodiments, the polygonal head 106 of the irrigation device 100 may be made from a durable, rigid metal material, such as aluminum, galvanized steel, stainless steel, brass, or other appropriate materials

The polygonal head 106 may include a port 107 that is operable to connect with a water delivery tubing and receive water therefrom. The upper end of the polygonal head 106 may be open and may include a connector structure, such as a barbed connection for a drip irrigation line. Connection to a drip irrigation line provides for the introduction of water or nutrient/water mixtures to the irrigation device 100, which will be distributed to the roots of a tree or other plant.

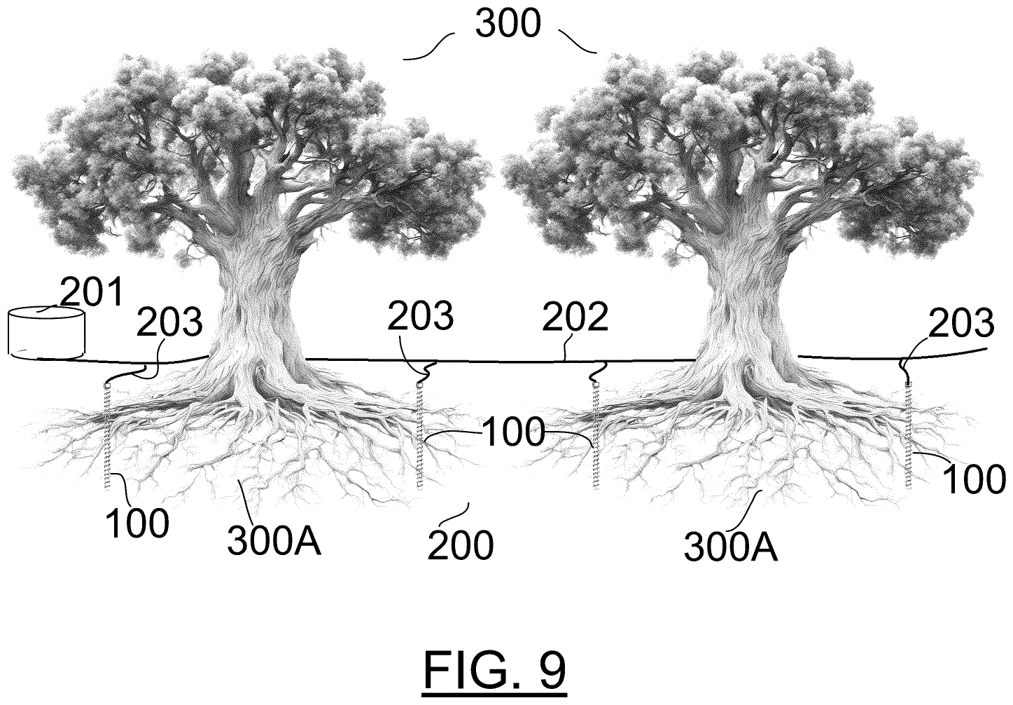

FIG. 9 shows an environmental view of an irrigation system 200 for water plants 300 directly at the root systems 300A of thereof. The irrigation devices 100 are driven into the soil near the plants 300. The irrigation system 200 may include a plurality of irrigation devices 100 inserted into the soil at the root systems 300A of plants 300 in order to more directly deliver water thereto. The irrigation devices 100 may be connected to a water source 201 (e.g., a well, reservoir, or irrigation canal). Water may be pumped from the water source 201 into main irrigation line 202 and then into sublines 203 to the irrigation devices 100. The irrigation devices 100 may then deliver the water or water/nutrient mixture to the root systems 300A at a subterranean level, avoiding the issues presented by surface irrigation.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. An irrigation device for dispersing fluid in an irrigation line beneath a soil surface, comprising:
a. at least one cylindrical tube body having
i. an upper end having a port for fluid communication with an irrigation line,
ii. a bottom end, and
iii. at least one sidewall having a plurality of emitter holes, each of said emitter holes in fluid communication with said port; and
b. a spiral threading on the exterior of the cylindrical tube body.

2. The device of claim 1, wherein said upper end has a polygonal shape.

3. The device of claim 1, wherein said bottom end has a tapered tip.

4-5. (canceled)

6. The device of claim 1, wherein said upper end is adapted to be positioned less than about one inch above the soil surface.

7. A plant watering system, comprising:
a. at least one irrigation device for dispending fluid beneath a surface of soil, said at least one irrigation device having
i. an irrigation line having said fluid therein;
ii. at least one cylindrical tube body having
1. an upper end having a port for fluid communication with said irrigation line,
2. a bottom end, and
3. at least one sidewall having a plurality of emitter holes, each of said emitter holes in fluid communication with said port; and
iii. a spiral threading on the exterior of the cylindrical tube body;
b. at least one connector engaged to said irrigation line and said port of said upper end.

8. The system of claim 7, wherein said upper end has a polygonal shape.

9. The system of claim 7, wherein said bottom end has a tapered tip.

10-11. (canceled)

12. The system of claim 7, wherein said upper end is adapted to be positioned less than about one inch above the soil surface.

13. The system of claim 23, wherein said cap structure comprises said port.

14. A method of installing an irrigation system comprising:
a. inserting at least one irrigation device into soil such that at least a portion of said device is present in a root system of a plant beneath a surface of soil, said at least one irrigation device having
i. at least one cylindrical tube body having
1. an upper end having a port for fluid communication with an irrigation line,
2. a bottom end, and
3. at least one sidewall having a plurality of emitter holes, each of said emitter holes in fluid communication with said port, and
ii. a spiral threading on the exterior of the cylindrical tube body;
b. engaging said irrigation line and said port of said upper end.

15. The method of claim 14, wherein said step of inserting said at least one irrigation device comprises connecting a tool to said upper end of said cylindrical tube and rotating said at least one irrigation device.

16. The method of claim 14, wherein said bottom end has a tapered tip.

17-18. (canceled)

19. The method of claim 14, wherein said upper end is adapted to be positioned less than about one inch above the soil surface.

20. The method of claim 24, wherein said cap structure comprises said port.

21. The device of claim 1, wherein said upper end further comprises a cap structure.

22. The device of claim 21, wherein said cap structure comprises said port.

23. The system of claim 7, wherein said upper end further comprises a cap structure.

24. The method of claim 14, wherein said upper end further comprises a cap structure.

25. The method of claim 14, wherein said upper end has a polygonal shape.

26. The method of claim 15, wherein said upper end has a hexagonal shape and said tool comprises a drill having a bit for receiving said upper end.
